(19) United States
(12) Patent Application Publication
(10) Pub. No.: US 2026/0167774 A1
(43) Pub. Date: Jun. 18, 2026

(54) DISPERSANT, CONDUCTIVE SLURRY, AND PREPARATION METHOD THEREOF AND USE THEREOF

(71) Applicants: Anhui Haofei New Material Co., Ltd., Anhui (CN); Shenzhen Haofei New Material Co., Ltd., Guangdong (CN); Shenzhen Haofei Industry Co., Ltd., Guangdong (CN)

(72) Inventor: Lingling HOU, Guangdong (CN)

(73) Assignees: Anhui Haofei New Material Co., Ltd., Anhui (CN); Shenzhen Haofei New Material Co., Ltd., Guangdong (CN); Shenzhen Haofei Industry Co., Ltd., Guangdong (CN)

(21) Appl. No.: 19/428,287

(22) Filed: Dec. 21, 2025

Related U.S. Application Data
(63) Continuation of application No. PCT/CN2023/141828, filed on Dec. 26, 2023.

(30) Foreign Application Priority Data
Aug. 30, 2023 (CN) 202311106920.7

(51) Int. Cl. C08G 63/91; C09D 5/24; C09D 7/20; C09D 7/45; C09D 7/61; C09D 7/65; H01M 4/62; H01M 10/0525

(52) U.S. Cl. CPC C08G 63/916; C09D 5/24; C09D 7/20; C09D 7/45; C09D 7/61; C09D 7/65; H01M 4/625; H01M 10/0525

(57) ABSTRACT

The present application provides a dispersant, and a conductive slurry and a preparation method thereof and use thereof. The dispersant includes any one or a combination of at least two of compounds having a structure represented by Formula I. The compounds having the structure represented by Formula I include both a polyester chain segment and a polyaniline chain segment, and have a strong adsorption effect on a conductive agent, and also good affinity for organic solvents, thereby effectively preventing agglomeration of the conductive agent in the organic solvents and improving the dispersity of the conductive agent in the organic solvents, so that the obtained conductive slurry has high conductivity, and has both low viscosity and high solid content, and is suitable for use in lithium-ion batteries.

### CROSS-REFERENCE TO RELATED APPLICATION

This application is a continuation of International Application No. PCT/CN2023/141828, filed on Dec. 26, 2023, which claims priority to Chinese Patent Application No. 202311106920.7, filed with the China National Intellectual Property Administration on Aug. 30, 2023, and entitled “DISPERSANT, CONDUCTIVE SLURRY, AND PREPARATION METHOD THEREOF AND USE THEREOF”. The disclosures of the aforementioned applications are hereby incorporated by reference in their entireties.

### TECHNICAL FIELD

The present application belongs to the technical field of conductive slurries, and in particular relates to a dispersant, a conductive slurry, and a preparation method thereof and a use thereof.

### BACKGROUND

As people's awareness of environmental protection continues to enhance, new energy battery has gradually been widely applied in automobile, energy storage and electronic equipment.

The conductive agent is an important component of new energy batteries, and its performance directly affects the electrical properties of the new energy batteries.

At present, commonly used conductive agents may be classified into zero-dimensional carbon nanomaterial, one-dimensional carbon nanomaterial and two-dimensional carbon nanomaterial according to their morphologies; among them, one-dimensional carbon nanomaterial and two-dimensional carbon nanomaterial have excellent conductive performance and have gradually become the research focus of researchers. CN113327700A discloses a low-viscosity, high-conductive carbon nanotube conductive slurry and its preparation method and use, where the carbon nanotube conductive slurry includes the following ingredients in parts by weight: 10 to 30 parts of a carbon nanotube, 2 to 10 parts of a dispersant and 400 to 750 parts of an organic solvent; the dispersant includes a combination of polyvinylpyrrolidone and hydroxyalkyl ammonium salt polymer. The preparation method includes the following steps: (1) mixing the carbon nanotube, the dispersant and the organic solvent to obtain a mixture; (2) subjecting the mixture obtained in step (1) to a mixing treatment to obtain an arrayed carbon nanotube conductive slurry. The carbon nanotube conductive slurry provided by this application has good conductivity, low viscosity and good storage stability, and is suitable for use in the field of lithium-ion batteries.

However, during the grinding and dispersion process of one-dimensional carbon nanomaterial and two-dimensional carbon nanomaterial in organic solvents, problems such as agglomeration and poor dispersibility are prone to occur, which affects the conductivity of the conductive slurry. It is usually necessary to add a dispersant for dispersion. Commonly used dispersants include polyvinylpyrrolidone (PVP), polyvinylidene fluoride (PVDF), etc. Although this type of dispersant improves the dispersion performance of one-dimensional carbon nanomaterial and two-dimensional carbon nanomaterial in organic solvents, it results in a relatively high viscosity of the obtained conductive slurry, making it is impossible to prepare a conductive slurry with a high conductive agent content, which limits the improvement of the conductive performance of the conductive slurry.

Therefore, in order to solve the above technical problems, there is an urgent need to develop a dispersant that can effectively improve the dispersion performance of the conductive slurry.

### SUMMARY

In view of the deficiencies in the prior arts, an object of the present application is to provide a dispersant, a conductive slurry, and a preparation method thereof and a use thereof. The dispersant includes a compound having a structure represented by Formula I. The structural formula of the above compound contains a polyester chain segment and a polyaniline chain segment, having a strong adsorption effect on the conductive agent while having good affinity for an organic solvent, thereby effectively preventing the conductive agent from agglomerating in the organic solvent, improving the dispersibility of the conductive agent in the organic solvent, and enabling the obtained conductive slurry to have both low viscosity and high solid content.

To achieve this object, the present application adopts the following technical solutions.

In a first aspect, the present application provides a dispersant, and the dispersant includes any one or a combination of at least two of compounds having a structure represented by Formula I:

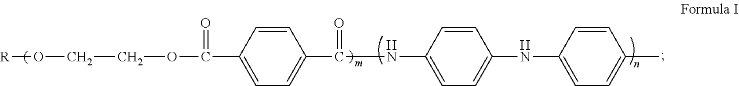

where, R is selected from alkyl groups, m is selected from integers between 1 and 500, and n is selected from integers between 1 and 10.

Where, m may be 20, 30, 40, 50, 60, 70, 80, 90, 100, 150, 200, 250, 300, 350, 400 or 450, etc.

n may be 2, 4, 6, 8 or 10, etc.

The dispersant provided by the present application includes any one or a combination of at least two of the compounds having the structure represented by Formula I. The above-mentioned compound having the structure represented by Formula I contains a polyester structural unit and a polyaniline structural unit, where the polyaniline structural unit has a strong surface adsorption effect on the conductive agent and can adsorb the conductive agent onto the material surface, and the polyester structural unit, which belongs to a solvated long chain, has a strong dispersion function and good affinity for organic solvents, which can effectively prevent the conductive agent adsorbed on the material surface from agglomerating, thereby effectively improving the dispersibility of the conductive agent in the organic solvent, so that the obtained conductive slurry can have both high solid content and low viscosity.

It should be noted that the present application imposes no special limitations on the preparation method of the provided compound having the structure represented by Formula I. Exemplarily, the compound can be prepared by the following method, which specifically includes the following steps.

(1) Terephthalic acid and ethylene glycol are reacted in the presence of a catalyst, and R—OH is added dropwise for end-capping to obtain a polyester; where R is selected from alkyl groups;
N-phenyl-1,4-p-phenylenediamine is oxidized by ferric ions to form an aniline oligomer.

(2) The polyester and the aniline oligomer obtained in step (1) are reacted to obtain the compound having the structure represented by Formula I.

In some embodiments, in step (1), a molar ratio of terephthalic acid to ethylene glycol is 1:(1.002 to 1.05), for example, 1:1.005, 1:1.007, 1:1.01, 1:1.02, 1:1.03 or 1:1.04, etc.

In some embodiments, in step (1), the catalyst includes p-methylbenzene sulfonic acid.

In some embodiments, based on an amount of the terephthalic acid in step (1) being 100%, an amount of the catalyst in step (1) is 0.1 to 2%, for example, 0.2%, 0.4%, 0.6%, 0.8%, 1%, 1.2%, 1.4%, 1.6% or 1.8%, etc.

In some embodiments, an amount of the R—OH in step (1) is a difference in molar amounts by which terephthalic acid is more than ethylene glycol.

In some embodiments, the above step (1) specifically includes: adding terephthalic acid and ethylene glycol into a reactor, and adding a catalyst, heating to 120 to 140° C. (e.g., 122° C., 124° C., 126° C., 128° C., 130° C., 132° C., 134° C., 136° C. or 138° C., etc.) using a steam bath, reacting for 1 h to 4 h (e.g., 1.5 h, 2 h, 2.5 h, 3 h or 3.5 h, etc.), to collect the effluent liquid under nitrogen protection, then heating to 160 to 195° C. (e.g., 165° C., 170° C., 175° C., 180° C., 185° C. or 190° C., etc.), slowly adding R—OH dropwise for end-capping to obtain the polyester.

In some embodiments, the above step (2) specifically includes: dissolving N-phenyl-1,4-p-phenylenediamine in diethyl ether, then slowly adding the mixture dropwise into hydrochloric acid with a concentration of 0.5 to 3 mol/L (e.g., 1 mol/L, 1.5 mol/L, 2 mol/L or 2.5 mol/L), mechanically stirring for 1 to 5 h (e.g., 2 h, 3 h or 4 h, etc.) to obtain a reaction solution, then adding a hydrochloric acid solution containing ferric chloride dropwise into the above reaction solution, continuing to stir for 1 to 5 h (e.g., 2 h, 3 h or 4 h, etc.), washing the precipitated solid with hydrochloric acid three times, then washing the precipitated solid once with ammonia water, and finally reducing the precipitated solid with hydrazine hydrate, and filtering to obtain the aniline oligomer.

In some embodiments, the above step (3) specifically includes: dissolving the polyester in dimethyl sulfoxide (DMSO), adding thionyl chloride for refluxing, reacting at 60 to 80° C. (e.g., 62° C., 64° C., 66° C., 68° C., 70° C., 72° C., 74° C., 76° C. or 78° C., etc.) for 1 to 3 h (e.g., 1.2 h, 1.4 h, 1.6 h, 1.8 h, 2 h, 2.2 h, 2.4 h, 2.6 h or 2.8 h, etc.), then distilling off the thionyl chloride under reduced pressure, and finally adding petroleum ether to precipitate the product, separating and drying the product for subsequent use, to obtain the treated polyester; dissolving the treated polyester and aniline oligomer in DMSO, heating to 170 to 190° C. (for example, 172° C., 174° C., 176° C., 178° C., 180° C., 182° C., 184° C., 186° C. or 188° C., etc.), and reacting for 2 to 4 h (for example, 2.2 h, 2.4 h, 2.6 h, 2.8 h, 3 h, 3.2 h, 3.4 h, 3.6 h or 3.8 h, etc.), discharging the product into distilled water, and then washing for multiple times, to obtain a compound having the structure represented by Formula I.

In some embodiments, R is selected from C1 to C20 alkyl groups, such as C2, C3, C4, C5, C6, C7, C8, C9, C10, C11, C12, C13, C14, C15, C16, C17, C18 or C19 alkyl group.

In some embodiments, m is selected from integers between 10 and 100.

In some embodiments, n is selected from integers between 4 and 10.

In a second aspect, the present application provides a conductive slurry, which includes the dispersant as in the first aspect, a conductive agent and a solvent.

The conductive slurry provided by the present application can be dispersed by adding the dispersant as in the first aspect, which can reduce the processing difficulty of the conductive slurry and at the same time, increase the solid content of the obtained conductive slurry.

In some embodiments, the conductive agent includes a carbon nanotube and/or graphene.

Where, the carbon nanotube may be powders from Tiannai Technology, and the graphene may be powders from Nanjing Xianfeng Nano.

In some embodiments, the conductive agent in the conductive slurry has a mass percentage content of 18% to 30%, for example, 19%, 21%, 22%, 23%, 24%, 25%, 26%, 27%, 28% or 29%, etc.

In some embodiments, the solvent is an organic solvent.

In some embodiments, the organic solvent includes N-methylpyrrolidone (NMP).

In some embodiments, the organic solvent in the conductive slurry has a mass percentage content of 65% to 80%, for example, 66%, 67%, 68%, 69%, 70%, 71%, 72%, 73%, 74%, 76% or 78%, etc.

In some embodiments, the dispersant as described in the first aspect in the conductive slurry has a mass percentage content of 2 to 6%, for example, 2.5%, 3%, 3.5%, 4%, 4.5%, 5% or 5.5%, etc.

As a technical solution of the present application, it is further limited that the mass percentage content of the dispersant in the conductive slurry is 2 to 6%. This enables the obtained conductive slurry to have excellent dispersion effect, and at the same time, it can ensure the lithium-ion battery has a high capacity when it is subsequently applied to the battery. If the mass percentage content of the dispersant in the conductive slurry is lower than 2%, the conductive slurry will have poor dispersibility, high viscosity and poor processing performance. If the mass percentage content of the dispersant in the conductive slurry is higher than 6%, it will, on one hand, have little effect on improving the dispersion effect of the conductive slurry, and on the other hand, when the conductive slurry is applied to the battery, the capacity of the battery will be reduced.

In some embodiments, a mass ratio of the dispersant to the conductive agent is 1:(4 to 10), for example, 1:4.5, 1:5, 1:5.5, 1:6, 1:6.5, 1:7, 1:7.5, 1:8, 1:8.5, 1:9 or 1:9.5.

In some embodiments, the conductive slurry further includes other dispersants, and the other dispersants include polyvinylpyrrolidone and/or polyvinylidene fluoride.

As a technical solution of the present application, other dispersants may also be added to the conductive slurry provided by the present application, to be used in combination with the dispersant described in the first aspect for dispersion.

In a third aspect, the present application provides a preparation method of the conductive slurry as described in the second aspect, which includes: mixing the dispersant as described in the first aspect, a conductive agent and a solvent or mixing the dispersant as described in the first aspect, a conductive agent, a solvent and other dispersant to obtain the conductive slurry.

In a fourth aspect, the present application provides a positive electrode slurry, which includes the conductive slurry as described in the second aspect.

In a fifth aspect, the present application provides use of the conductive slurry as described in the second aspect in a lithium-ion battery.

Compared with the prior arts, the present application has the following beneficial effects:

The dispersant provided by the present application includes any one or a combination of at least two of compounds having a structure represented by Formula I. The aforementioned compounds having the structure represented by Formula I contain both a polyester chain segment and a polyaniline chain segment, and not only have a strong adsorption effect on the conductive agent, but also have good affinity for organic solvents, thereby effectively preventing the conductive agent from agglomerating in the organic solvents, improving the dispersibility of the conductive agent in the organic solvents, so that the obtained conductive slurry has a high conductivity, and has both low viscosity and high solid content, and is suitable for use in lithium-ion batteries.

### DESCRIPTION OF EMBODIMENTS

The technical solutions of the present application are further described below through specific embodiments. It should be understood by those skilled in the art that the embodiments are only for helping to understand the present application and shall not be regarded as specific limitations on the present application.

### Example 1

A dispersant M1, having a specific structural formula as follows, was prepared:

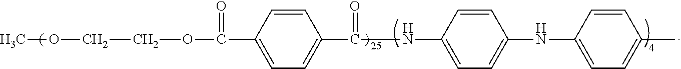

The preparation method of the dispersant M1 provided by the present example includes the following steps.

(1) 6.207 g of ethylene glycol and 17.444 g of terephthalic acid were added into a reactor, followed by the addition of 0.1744 g of p-methylbenzene sulfonic acid, then mixture was heated to 130° C. using a steam bath, and reacted for 90 min, and under nitrogen protection, the effluent liquid was collected; the temperature was then raised to 180° C., and 0.16 g of methanol was slowly added dropwise for end-capping, to obtain a polyester;
9.2 g of N-phenyl-1,4-p-phenylenediamine monomer was dissolved in 100 mL of anhydrous diethyl ether, and the mixture was slowly added dropwise to 1000 mL of hydrochloric acid with a concentration of 1 mol/L, and mechanically stirred for 4 h to obtain a reaction solution; 14 g of ferric chloride hexahydrate was dissolved in 150 mL of hydrochloric acid with a concentration of 1 mol/L, and the obtained hydrochloric acid solution containing ferric chloride was slowly added dropwise to the aforementioned reaction solution, and the mixture continued to be stirred for 4 h, a solid was obtained by suction filtration, and the obtained solid was washed three times using hydrochloric acid with a concentration of 1 mol/L, and then washed once with 1 mol/L ammonia water, and finally reduced with hydrazine hydrate, and after suction filtration, a crude product was obtained, and the crude product was vacuum-dried for 72 h to obtain an aniline oligomer.

(2) 22 g of the polyester obtained in step (1) was dissolved in 120 mL of DMSO, 6 mL of thionyl chloride was added, and the mixture was heated to 70° C., reacted for 2 h, then thionyl chloride was distilled off the under reduced pressure, then the solution was added to petroleum ether, and the precipitate was filtered and dried to obtain a treated polyester.

(3) 9.558 g of the treated polyester obtained in step (2) and 1.458 g of the aniline oligomer obtained in step (1) were added to 40 mL of DMSO for dissolution, and the mixture was heated to 180° C., and reacted for 3 h, and the product was discharged into distilled water and washed 5 times to obtain the dispersant M1.

### Characterization Data:

A nuclear magnetic resonance spectrometer (Varian-300) was adopted to test the dispersant M1 provided by the present example. In the H-NMR spectrum obtained by the test, a single peak appeared at 8.4 ppm, which confirms the formation of an amide bond. A Fourier transform infrared spectrometer was adopted to test the dispersant M1 provided by the present example. In the infrared spectrum obtained by the test, a new peak appeared at 1400 cm-1, which is the carbon-nitrogen stretching peak of the amide bond. All the above results confirm that the dispersant M1 having the above-mentioned specific structure was successfully synthesized in Example 1.

### Example 2

A dispersant M2, having a specific structural formula as follows, was prepared:

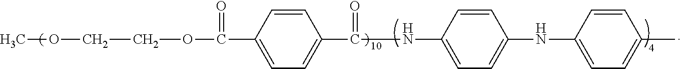

The preparation method of the dispersant M2 provided by the present example includes the following steps.

(1) 6.207 g of ethylene glycol and 18.274 g of terephthalic acid were added into a reactor, followed by the addition of 0.1827 g of p-methylbenzene sulfonic acid, then the mixture was heated to 130° C. using a steam bath, and reacted for 90 min, and under nitrogen protection, the effluent liquid was collected, and the temperature was then raised to 180° C., and 0.32 g of methanol was slowly added dropwise for end-capping, to obtain a polyester;
9.2 g of N-phenyl-1,4-p-phenylenediamine monomer was dissolved in 100 mL of anhydrous diethyl ether, and the mixture was slowly added dropwise to 1000 mL of hydrochloric acid with a concentration of 1 mol/L, and mechanically stirred for 4 h to obtain a reaction solution; 14 g of ferric chloride hexahydrate was dissolved in 150 mL of hydrochloric acid with a concentration of 1 mol/L, and the obtained hydrochloric acid solution containing ferric chloride was slowly added dropwise to the aforementioned reaction solution, and the mixture continued to be stirred for 4 h, a solid was obtained by suction filtration, and the obtained solid was washed three times using hydrochloric acid with a concentration of 1 mol/L, and then washed once with 1 mol/L ammonia water, and finally reduced with hydrazine hydrate, and after suction filtration, a crude product was obtained, and the crude product was vacuum-dried for 72 h to obtain an aniline oligomer.

(2) 22 g of the polyester obtained in step (1) was dissolved in 120 mL of DMSO, 6 mL of thionyl chloride was added, then the mixture was heated to 70° C., and reacted for 2 h, then thionyl chloride was distilled off the under reduced pressure, then the solution was added to petroleum ether, and the precipitate was filtered and dried to obtain a treated polyester.

(3) 5.806 g of the treated polyester obtained in step (2) and 3.6416 g of the aniline oligomer obtained in step (1) were added to 32 mL of DMSO for dissolution, the mixture was heated to 180° C., and reacted for 3 h, and the product was discharged into distilled water and washed 5 times to obtain the dispersant M2.

### Characterization Data:

A nuclear magnetic resonance spectrometer (Varian-300) was adopted to test the dispersant M2 provided by the present example. In the H-NMR spectrum obtained by the test, a single peak appeared at 8.4 ppm, which confirms the formation of an amide bond. A Fourier transform infrared spectrometer was adopted to test the dispersant M2 provided by the present example. In the infrared spectrum obtained by the test, a new peak appeared at 1400 cm-1, which is the carbon-nitrogen stretching peak of the amide bond. All the above results confirm that the dispersant M2 having the above-mentioned specific structure was successfully synthesized in Example 2.

### Example 3

A dispersant M3, having a specific structural formula as follows, was prepared:

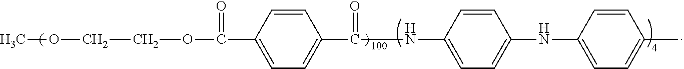

The preparation method of the dispersant M3 provided by the present example includes the following steps.

(1) 6.207 g of ethylene glycol and 16.779 g of terephthalic acid were added into a reactor, followed by the addition of 0.1678 g of p-methylbenzene sulfonic acid, then the mixture was heated to 130° C. using a steam bath, and reacted for 90 min, and under nitrogen protection, the effluent liquid was collected, the temperature was then raised to 180° C., and 0.32 g of methanol was slowly added dropwise for end-capping, to obtain a polyester;
9.2 g of N-phenyl-1,4-p-phenylenediamine monomer was dissolved in 100 mL of anhydrous diethyl ether, and the mixture was slowly added dropwise to 1000 mL of hydrochloric acid with a concentration of 1 mol/L, and mechanically stirred for 4 h to obtain a reaction solution; 14 g of ferric chloride hexahydrate was dissolved in 150 mL of hydrochloric acid with a concentration of 1 mol/L, and the obtained hydrochloric acid solution containing ferric chloride was slowly added dropwise to the aforementioned reaction solution, and the mixture continued to be stirred for 4 h, then a solid was obtained by suction filtration, and the obtained solid was washed three times using hydrochloric acid with a concentration of 1 mol/L, and then washed once with 1 mol/L ammonia water, and finally reduced with hydrazine hydrate, and after suction filtration, a crude product was obtained, and the crude product was vacuum-dried for 72 h to obtain an aniline oligomer.

(2) 22 g of the polyester obtained in step (1) was dissolved in 120 mL of DMSO, 6 mL of thionyl chloride was added, then the mixture was heated to 70° C., and reacted for 2 h, then thionyl chloride was distilled off the under reduced pressure, then the solution was added to petroleum ether, and the precipitate was filtered and dried to obtain a treated polyester.

(3) 19.204 g of the treated polyester obtained in step (2) and 0.728 g of the aniline oligomer obtained in step (1) were added to 32 mL of DMSO for dissolution, the mixture was heated to 180° C., and reacted for 2 h, and the product was discharged into distilled water and washed 5 times to obtain the dispersant M3.

### Characterization Data:

A nuclear magnetic resonance spectrometer (Varian-300) was adopted to test the dispersant M3 provided by the present example. In the H-NMR spectrum obtained by the test, a single peak appeared at 8.4 ppm, which confirms the formation of an amide bond. A Fourier transform infrared spectrometer was adopted to test the dispersant M3 provided by the present example. In the infrared spectrum obtained by the test, a new peak appeared at 1400 cm-1, which is the carbon-nitrogen stretching peak of the amide bond. All the above results confirm that the dispersant M3 having the above-mentioned specific structure was successfully synthesized in Example 3.

### Comparative Example 1

A polyvinylpyrrolidone (PVP), having a number-average molecular weight of 40,000, was provided.

### Comparative Example 2

A polyvinylidene fluoride (PVDF), having a number-average molecular weight of 1,200,000, was provided.

### Application Example 1

A conductive slurry, consisting of NMP, the dispersant M1 provided by Example 1, and a carbon nanotube, with their mass percentage contents being 70%, 5%, and 25% in sequence, was prepared.

The preparation method of the conductive slurry provided by the present Application Example 1 includes the following steps:
(1) mixing the dispersant M1 provided by Example 1 with NMP uniformly to obtain a glue solution;
(2) adding the carbon nanotube into the glue solution obtained in step (1) and grinding the mixture evenly to obtain the conductive slurry.

### Application Example 2

A conductive slurry, consisting of NMP, the dispersant M2 provided by Example 2, and graphene, with their mass percentages being 65%, 6%, and 29% in sequence, was prepared.

The preparation method of the conductive slurry provided by the present Application Example 2 includes the following steps:
(1) mixing the dispersant M2 provided by Example 2 with NMP uniformly to obtain a glue solution;
(2) adding the graphene into the glue solution obtained in step (1) and grinding the mixture evenly to obtain the conductive slurry.

### Application Example 3

A conductive slurry, consisting of NMP, the dispersant M3 provided by Example 3, and a carbon nanotube, with their mass percentages being 75%, 4%, and 21% in sequence, was prepared.

The preparation method of the conductive slurry provided by the present Application Example 3 includes the following steps:
(1) mixing the dispersant M3 provided by Example 3 with NMP uniformly to obtain a glue solution;
(2) adding the carbon nanotube into the glue solution obtained in step (1) and grinding the mixture evenly to obtain the conductive slurry.

### Application Example 4

A conductive slurry, which differs from Application Example 1 only in that the mass percentage contents of NMP, the dispersant M1 provided by Example 1 and the carbon nanotube are 80%, 2% and 18% respectively, was prepared. The preparation method is in accordance with that of Application Example 1.

### Application Example 5

A conductive slurry, which differs from Application Example 1 only in that the mass percentage contents of NMP, the dispersant M1 provided by Example 1 and the carbon nanotube are 70%, 6% and 24% respectively, was prepared. The preparation method is in accordance with that of Application Example 1.

### Application Example 6

A conductive slurry, which differs from Application Example 1 only in that the mass percentage contents of NMP, the dispersant M1 provided by Example 1 and the carbon nanotube are 70%, 1% and 29% respectively, was prepared. The preparation method is in accordance with that of Application Example 1.

### Application Example 7

A conductive slurry, which differs from Application Example 1 only in that the mass percentage contents of NMP, the dispersant M1 provided by Example 1 and the carbon nanotube are 70%, 8% and 22% respectively, was prepared. The preparation method is in accordance with that of Application Example 1.

### Application Example 8

A conductive slurry, consisting of NMP, the dispersant M1 provided by Example 1, PVP (number-average molecular weight of 40,000) and a carbon nanotube with their mass percentages being 70%, 3%, 2%, and 25% in sequence, was prepared.

The preparation method of the conductive slurry provided by the present Application Example 8 includes the following steps:
(1) mixing the dispersant M1 provided by Example 1, PVP, and NMP uniformly to obtain a glue solution;
(2) adding the carbon nanotube into the glue solution obtained in step (1) and grinding the mixture evenly to obtain the conductive slurry.

### Comparative Application Example 1

A conductive slurry was prepared, which differs from Application Example 1 only in that the PVP dispersant provided by Comparative Example 1 is adopted to replace the dispersant M1 provided by Example 1; and the other substances and their amounts and the preparation method are all the same as in Application Example 1.

### Comparative Application Example 2

A conductive slurry was prepared, which differs from Application Example 1 only in that the PVDF dispersant provided by Comparative Example 2 is adopted to replace the dispersant M1 provided by Example 1; and the other substances and their amounts and the preparation method are all the same as in Application Example 1.

### Performance Testing:

(1) Conductive agent content: determined by calculating the mass percentage content of the conductive agent in the conductive slurry.

(2) Viscosity: tested in accordance with the test method provided in GB/T10247-2008, where a Brookfield rotational viscometer is adopted for test, with a temperature being 25° C., a No. 4 rotor employed, and a rotational speed ranging from 6 to 60 rpm.

The conductive slurries provided in Application Examples 1 to 8 and Comparative Application Examples 1 to 2 were tested according to the above test methods, and the test results are shown in Table 1:

TABLE 1

| | Conductive | Viscosity/ |
|---|---|---|
| | agent content/% | mPa · s |
| Application Example 1 | 25 | 3,576 |
| Application Example 2 | 29 | 3,877 |
| Application Example 3 | 21 | 3,620 |
| Application Example 4 | 18 | 5,850 |
| Application Example 5 | 24 | 2,999 |
| Application Example 6 | 29 | 24,655 |
| Application Example 7 | 22 | 2,705 |
| Application Example 8 | 25 | 13,576 |
| Comparative Application | 25 | Greater than 30,000 |
| Example 1 | | |
| Comparative Application | 25 | Greater than 30,000 |
| Example 2 | | |

According to the data in Table 1, it can be seen that under the condition of the same mass percentage content of the conductive agent, the viscosity of the conductive slurry prepared by using the dispersant having the structure represented by Formula I provided by the present application is reduced, indicating better dispersion effect and more excellent processing performance.

Specifically, the mass percentage contents of the conductive agents in the conductive slurries obtained in Application Examples 1 to 3 and Application Example 5 are as high as 21% to 25%, but the viscosity is only 2,999 to 3,877 mPa·s, all lower than 4,000 mPa·s, showing extremely excellent processing performance.

By comparing the data of Application Example 1 with Comparative Application Examples 1-2, it can be seen that under the condition where the mass percentage content of the conductive agent is the same, the viscosity of the conductive slurries prepared by using the conventional dispersants provided in Comparative Examples 1-2 is higher than 30,000 mPa s, with the conductive agent dispersed very unevenly, resulting in difficult processing.

Further, by comparing the data of Application Example 1, Application Example 4, and Application Examples 6-8, it can be found that an excessively low mass ratio of dispersant to carbon nanotube in the conductive slurry leads to an increase in the viscosity of the conductive slurry. If the mass ratio of dispersant to carbon nanotube in the conductive slurry is excessively high, the dispersant has little effect on improving the dispersion effect of the conductive slurry, and the application of such a conductive slurry in batteries results in a reduction in battery capacity.

The applicant declares that the present application describes a dispersant, a conductive slurry, and a preparation method thereof, and a use thereof through the above-mentioned embodiments, but the present application is not limited to the above-mentioned embodiments, that is, it does not mean that the present application must rely on the above-mentioned examples for implementation. Those skilled in the art should understand that any improvement to the present application, the equivalent replacement of various raw materials of the product of the present application, the addition of auxiliary ingredients, and the selection of specific methods, etc., all fall within the protection scope and disclosure scope of the present application.

What is claimed is:

1. A dispersant, comprising any one or a combination of at least two of compounds having a structure represented by Formula I: 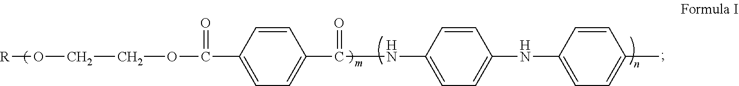
wherein, R is selected from alkyl groups, m is selected from integers between 1 and 500, and n is selected from integers between 1 and 10.

2. The dispersant according to claim 1, wherein R is selected from C1 to C20 alkyl groups.

3. The dispersant according to claim 2, wherein R is selected from C1 to C5 alkyl groups.

4. The dispersant according to claim 1, wherein m is selected from integers between 10 and 100.

5. The dispersant according to claim 1, wherein n is selected from integers between 4 and 10.

6. A conductive slurry, comprising the dispersant according to claim 1, a conductive agent and a solvent.

7. The conductive slurry according to claim 6, wherein the conductive agent comprises a carbon nanotube and/or graphene.

8. The conductive slurry according to claim 6, wherein the conductive agent has a mass percentage content of 18% to 30% in the conductive agent slurry.

9. The conductive slurry according to claim 6, wherein the solvent is an organic solvent.

10. The conductive slurry according to claim 9, wherein the organic solvent comprises N-methylpyrrolidone.

11. The conductive slurry according to claim 9, wherein the organic solvent has a mass percentage content of 65% to 80% in the conductive slurry.

12. The conductive slurry according to claim 6, wherein the dispersant has a mass percentage content of 2% to 6% in the conductive slurry.

13. The conductive slurry according to claim 6, wherein a mass ratio of the dispersant to the conductive agent is 1:(4 to 10).

14. The conductive slurry according to claim 13, wherein a mass ratio of the dispersant to the conductive agent is 1:(4 to 6).

15. The conductive slurry according to claim 6, wherein the conductive slurry further comprises other dispersants, and the other dispersants comprise polyvinylpyrrolidone and/or polyvinylidene fluoride.

16. A preparation method of the conductive slurry according to claim 6, comprising: mixing the dispersant, the conductive agent, the solvent and optionally other dispersants to obtain the conductive slurry.

17. A positive electrode slurry, comprising the conductive slurry according to claim 6.

18. Use of the conductive slurry according to claim 6 in a lithium-ion battery.
